(19) United States
(12) Patent Application Publication
(10) Pub. No.: US 2026/0172738 A1
(43) Pub. Date: Jun. 18, 2026

(54) Wearable Audio Device Active Noise Cancellation System

(71) Applicant: Google LLC, Mountain View, CA (US)

(72) Inventors: Bryan Alan Macomber, San Francisco, CA (US); Troy Jason Edwards, Los Gatos, CA (US); Yao Xue, San Jose, CA (US); Mi Zhou, San Jose, CA (US); Bryan Thov, Sunnyvale, CA (US); Guohua Sun, Santa Clara, CA (US); Jason David Walker, Mountain View, CA (US)

(21) Appl. No.: 18/982,947

(22) Filed: Dec. 16, 2024

(51) Int. Cl. H04R 1/10

(52) U.S. Cl. CPC H04R 1/1083; H04R 1/1016

(57) ABSTRACT

A wearable audio device includes a housing defining a body and an active noise cancellation system contained within the body. The active noise cancellation system includes a speaker, a microphone spaced from the speaker, and an acoustic deflector arranged between the microphone and the speaker. The acoustic deflector is configured to optimize a first audio path between a port of the microphone and the speaker based on a second audio path between the port of the microphone and a reference point.

### FIELD

The present disclosure relates generally to wearable audio devices, and more particularly, to wearable audio devices, such as earbuds, having a noise cancellation system.

### BACKGROUND

Wearable audio devices, in-ear headphones, or earbuds, are becoming increasingly popular due to their functionality, ease of use, and communication capability (e.g., Bluetooth®) with many computing devices. Wearable audio devices are generally portable audio playback devices through which a user can playback or listen to various audio signals. A user may utilize such a portable wearable audio device while travelling or moving through various different environments. Further, certain wearable audio devices may be designed to block out environmental audio signals, e.g., via active noise cancellation. A design aspect of many active noise cancellation system is locating and orientating a microphone so as to balance limiting howling instability due to phase lag and occlusion of an acoustic opening with maximizing noise cancellation performance. Packaging constraints of wearable audio devices may limit placement and orientation of the microphone within the wearable audio device.

### SUMMARY

Aspects and advantages of embodiments of the present disclosure will be set forth in part in the following description, or can be learned from the description, or can be learned through practice of the embodiments.

In an aspect, the present disclosure is directed to a wearable audio device. The wearable audio device includes a housing defining a body and an active noise cancellation system contained within the body. The active noise cancellation system includes a speaker, a microphone spaced from the speaker, and an acoustic deflector arranged between the microphone and the speaker. The acoustic deflector is configured to optimize a first audio path between a port of the microphone and the speaker based on a second audio path between the port of the microphone and a reference point.

In another aspect, the present disclosure is directed to an active noise cancellation system for a wearable audio device. The active noise cancellation system includes a speaker, a microphone spaced from the speaker, and an acoustic deflector arranged between the microphone and the speaker. The acoustic deflector is configured to optimize a first audio path between a port of the microphone and the speaker based on a second audio path between the port of the microphone and a reference point.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 is a pictorial diagram of an embodiment of a wearable audio device in accordance with example embodiments of the present disclosure;

FIG. 2 is a functional block diagram of a control system for a wearable audio device in accordance with example embodiments of the present disclosure;

FIG. 3 is a cross-sectional view of an embodiment of an earbud assembly in a user's ear in accordance with example embodiments of the present disclosure; and

FIG. 4 illustrates an enlarged view of a portion of the earbud assembly of FIG. 3 in accordance with example embodiments of the present disclosure.

FIG. 5 is a cross-sectional view of a portion of an earbud assembly lacking an acoustic deflector and illustrating a difference between lengths along first and second audio paths.

FIG. 6 is a cross-sectional of the portion of the earbud assembly of FIG. 3 including the acoustic deflector in accordance with example embodiments of the present disclosure and illustrating substantially equal lengths along the first and second audio paths.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Certain wearable device may be designed to reduce or substantially eliminate ambient environmental audio signals in order to improve the user's listening experience by preventing the environmental audio signals from interfering with the audio playback on the wearable audio device. Such wearable audio devices may be termed “noise cancelling headphones,” “earbuds,” and the like. Noise cancellation may generally be divided into “passive” and “active” techniques, which may be used in combination to reduce the influence of environmental noise. Passive noise cancellation may attenuate external audio sources by physically isolating the user's ears from the environment. This may be accomplished, for example, by the placement of a material which surrounds or is inserted into the user's ears (depending on the style of wearable audio device) in order to prevent audio signals from directly travelling through the air into the user's ears. Active noise cancellation may attenuate an external audio source, for example, by producing an audio signal that is substantially out of phase with the external audio source to cancel the external audio source via destructive interference.

In order to implement active noise cancellation, an audio signal may be generated to destructively interfere with an ambient audio signal received by a microphone contained within the wearable audio device. However, due to packaging constraints within the wearable audio device, arrangement of the microphone within the wearable audio device may be limited. As such, arranging the microphone to satisfy packaging constraints may come at the cost of sacrificing performance of the active noise cancellation and/or the audio playback. For example, when a port of the microphone faces away from the speaker and towards an acoustic opening of the wearable audio device, active noise cancellation may be improved, but one or more audio aspects of the audio playback (e.g., such as howling stability due to phase lag, occlusion at an acoustic opening, etc.) may be compromised. Alternatively, when the port of the microphone faces towards the speaker and away from the acoustic opening of the wearable audio device, one or more audio aspects of the audio playback may be improved, but active noise cancellation may be compromised.

Accordingly, the present disclosure is directed to a wearable audio device having an active noise cancellation system that includes an acoustic deflector. The acoustic deflector is configured to optimize a first audio path from the port of the microphone to the speaker based on a second audio path from the port of the microphone to a reference point. As such, the acoustic deflector can be used to optimize active noise cancellation and the audio playback of the wearable audio device while satisfying packaging constraints of the wearable audio device.

With reference now to the Figures, example embodiments of the present disclosure will be discussed in further detail.

### Example Devices and Systems

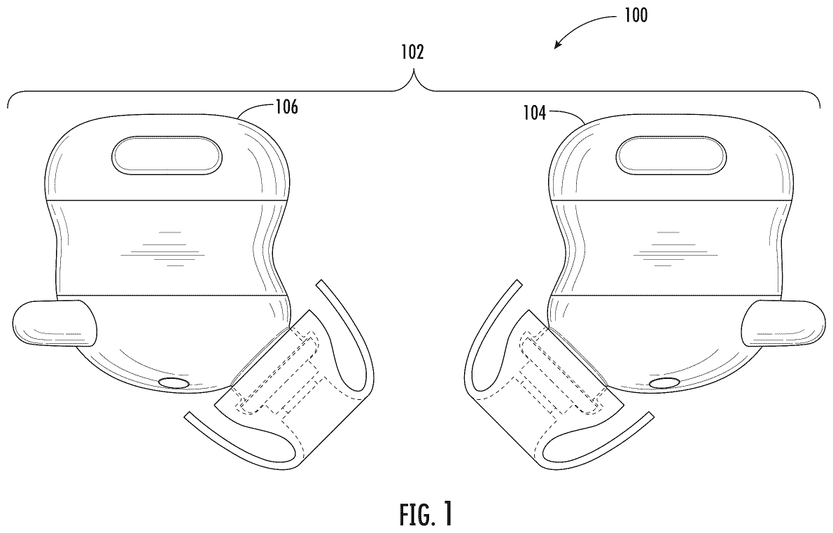

Referring now to the drawings, FIG. 1 illustrates a view of a wearable audio device 100 according to the present disclosure. In an embodiment, the wearable audio device 100 may be a device that is capable of detecting and/or receiving audio input using one or more microphones. In an embodiment, the wearable audio device 100 may be earbuds, a headset, a VR/AR headset, etc. In particular, as shown, the wearable audio device 100 is a pair 102 of earbuds 104, 106.

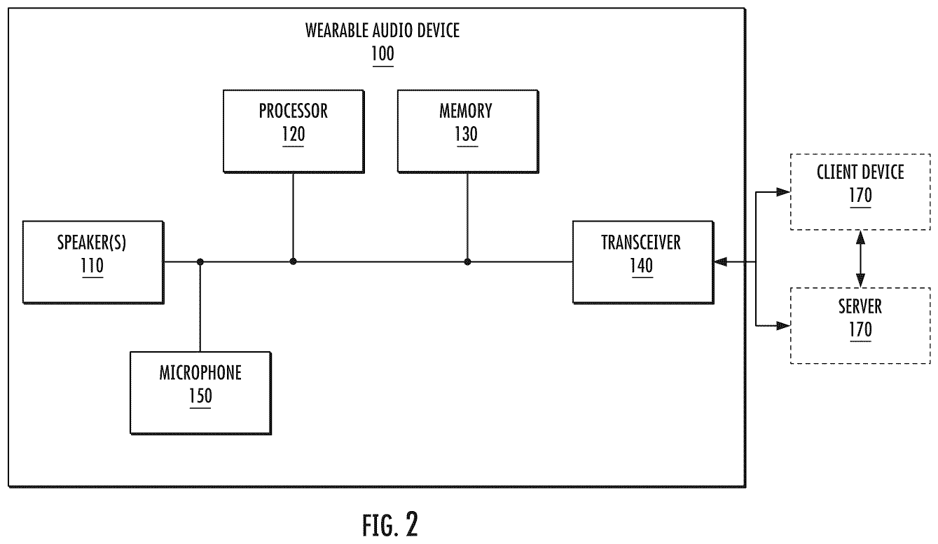

Referring now to FIG. 2, a block diagram illustrating certain components of an example wearable audio device 100 according to the present disclosure is shown. As shown in FIG. 2, the wearable audio device 100 may include one or more speaker(s) 110, a processor (or processor circuit) 120, a memory (or memory circuit) 130, a transceiver 140, and a microphone 150. In other embodiments, the wearable audio device 100 may include additional components and/or include a subset of the illustrated components. The wearable audio device 100 may further be in communication with external devices, such as client device 170 and/or a server 175.

In one implementation, the wearable audio device 100 may include one or more speakers, such as a pair of speakers 110, each configured to supply a right or left audio signal to a corresponding one of a user's ears. The speakers 110 may be designed to be placed over and/or inserted into the user's ears to provide audio signals thereto. The processor 120 may be configured to transcode an audio signal into a format (e.g., an analog format) to be applied to the speakers 110. Alternatively, the speakers 110 may directly receive an audio signal for playback from the transceiver 140 or the speakers 110 may include one or more dedicated processors (not illustrated) for transcoding audio signals for playback.

The memory 130 may store executable instructions for causing the processor 120 to perform one or more operations in accordance with this disclosure. Additionally, in certain implementations, the memory 130 may also store audio signals for playback via the speakers 110. The transceiver 140 may be configured to receive signals from external devices, such as the client device 170 and/or the server 175. The client device 170 may include, for example, a wearable electronic device (e.g., a biometric monitoring or activity tracking device), a mobile phone, a music/media player (e.g., a portable music player), a camera, a weight scale, etc. Depending on the implementation, the client device 170 may be any device capable of communicating with the wearable audio device 100. The transceiver 140 may be configured to communicate with the external device(s) wirelessly and/or via one or more wired connections. The microphone 150 of the wearable audio device 100 may be configured to receive audio signals from the environment, which may be processed by the processor 120. The microphone 150 may also be used as an input device for receiving audio commands from the user of the wearable audio device 100. In certain implementations, the audio signals received by the microphone 150 may also be used by the processor 120 for active noise cancellation.

In order to implement active noise cancellation, the processor 120 may generate an audio signal designed to destructively interfere with the ambient audio signal, which may be received by the microphone 150. The generated noise cancellation audio signal may be played by the speakers 110 used for audio playback to the user or may be played by dedicated speakers 110 in addition to those speakers used for playback of audio to the user.

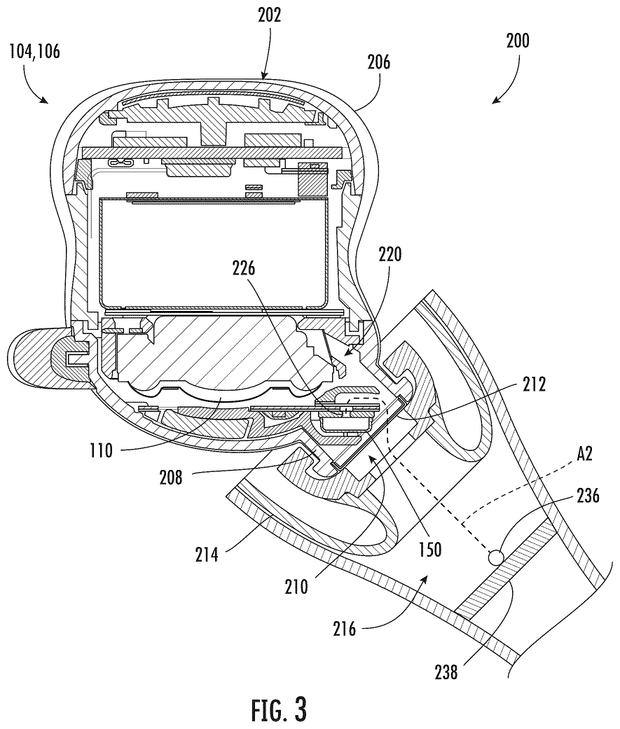

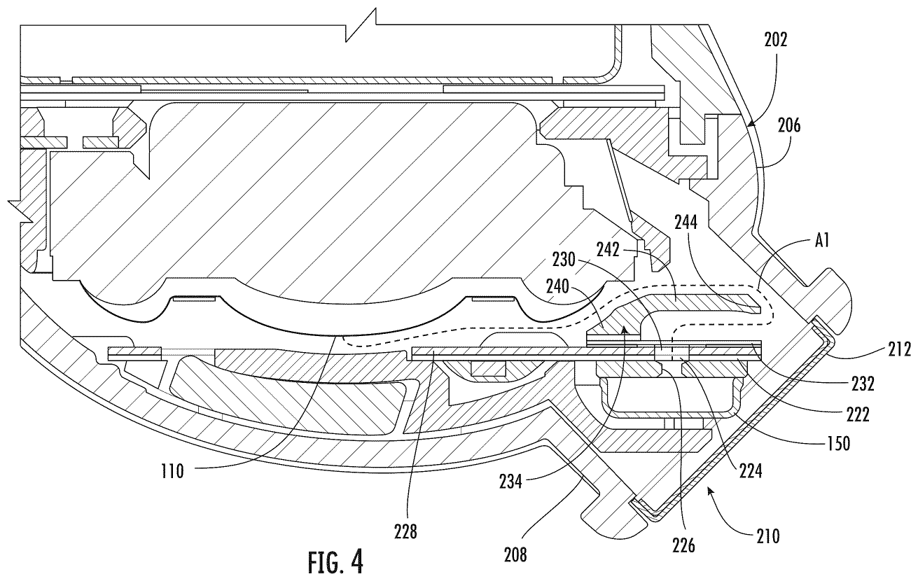

Referring now to FIGS. 3 and 4, cross-sectional views of an earbud assembly 200 containing one of the earbuds 104, 106 described herein according to the present disclosure are illustrated. In particular, FIG. 3 illustrates a cross-sectional view of an embodiment of the earbud assembly 200 containing one of the earbuds 104, 106 described herein according to the present disclosure. Moreover, FIG. 4 illustrates an enlarged view of a portion of the earbud assembly 200 shown in FIG. 3.

Referring particularly to FIG. 3, as shown, the earbud assembly 200 includes a housing 202 containing one or more electrical components therein. In particular, the electrical components include the speaker 110 and the microphone 150. The electrical components may further include, but are not limited to, a battery, wiring, a driver, and/or any other suitable electrical components for permitting the earbud assembly 200 to perform the operations described herein.

Further, in an embodiment, the housing 202 defines a body 206, such as a rigid body. In embodiments, the body 206 may include at least one protrusion 208 extending therefrom. The at least one protrusion 208 may, for example, define an acoustic opening 210 (e.g., through which audio signals pass into and/or out of the earbud assembly 200). The acoustic opening 210 may be covered by an earbud cover 212. The earbud cover 212 may be configured to prevent debris from entering into the earbud assembly 200. Further, the earbud cover 212 may be configured to permit audio signals to pass therethrough without attenuating or enhancing the audio signals. For example, the earbud cover 212 may be an acoustic mesh. The earbud cover 212 may be formed of any suitable material (e.g., metal, fabric, polymers, etc.) for blocking debris without hindering acoustic performance.

Moreover, the earbud assembly 200 may include a flexible sleeve tip 214 secured over at least a portion of the body 206. For example, as shown, the flexible sleeve tip 214 may be secured over at least a portion of the protrusion 208. In an embodiment, the flexible sleeve tip 214 may be constructed of flexible materials including but not limited to silicone, rubber, polymers such as memory foam (polyurethane), etc. As such, the flexible sleeve tip 214 is configured to fit within an ear canal 216 of a user.

Referring still to FIG. 3, the earbud assembly 200 further includes an active noise cancellation system 220. The active noise cancellation system 220 includes one or more of the electrical components contained within the housing 202, such as the speaker 110 and the microphone 150. The microphone 150 may be arranged, at least partially in the protrusion 208, and proximate to the acoustic opening 210. The microphone 150 includes a port 226 configured to receive audio signals. The port 226 may face away from the acoustic opening 210 (i.e., into the housing 202). Arranging the port 226 to face away from the acoustic opening 210 may improve one or more acoustic aspects of the audio playback provided to the user (e.g., by reducing occlusion at the acoustic opening 210 and improving howling stability due to phase lag as compared designs that arrange the port 226 to face the acoustic opening 210).

Referring particularly to FIG. 4, the active noise cancellation system 220 may include any other suitable electrical components for performing active noise cancellation. For example, the active noise cancellation system 220 may include a circuit board 222. The circuit board 222 may support one or more components of the wearable audio device 100, such as the processor 120, the memory 130, the transceiver 140, etc. Further, the circuit board 222 may abut the microphone 150. In embodiments, the circuit board 222 may be connected to the microphone 150 (e.g., via any suitable manner, such as via adhesives).

Moreover, the circuit board 222 may include a first hole 224 extending therethrough. The first hole 224 may be aligned with the port 226 of the microphone 150, as shown. Aligning the first hole 224 with the port 226 allows audio signals to pass through the circuit board 222 and be received by the microphone 150 (e.g., via the port 226).

In embodiments, the circuit board 222 may be a flexible circuit board. That is, the circuit board 222 may be formed of any suitable flexible material, such as polymides, polymers, etc. In such embodiments, the earbud assembly 200 may further include a stiffener 228, as shown in FIG. 4. The circuit board 222 may be arranged between the stiffener 228 and the microphone 150. The stiffener 228 may be connected to the circuit board 222 (e.g., in any suitable manner, such as via adhesives). More particularly, the stiffener 228 may be configured to provide mechanical support and stiffness to the circuit board 222. The stiffener 228 may be formed of any suitable rigid material (e.g., metal, fiberglass, etc.).

Further, the stiffener 228 may include a second hole 230 extending therethrough. The second hole 230 may be aligned with the first hole 224 so as to permit audio signals to pass through the stiffener 228 as well the circuit board 222 and be received by the microphone 150 (e.g., via the port 226). In alternative embodiments, the circuit board 222 may be formed of a rigid material (such as fiberglass or any other suitable material for forming circuit boards) such that the stiffener 228 can be omitted.

Referring still to FIG. 4, the active noise cancellation system 220 may include an acoustic mesh 232, as shown. The acoustic mesh 232 may be connected to the stiffener 228 (or to the circuit board 222, such as in embodiments where the stiffener 228 is omitted). The acoustic mesh 232 may be connected to the stiffener 228 (or the circuit board 222, such as in embodiments where the stiffener 228 is omitted) in any suitable manner (e.g., via adhesives). In embodiments, the circuit board 222 may be arranged between the acoustic mesh 232 and the microphone 150. In certain embodiments, the stiffener 228 may be arranged between the acoustic mesh 232 and the circuit board 222. Further, the acoustic mesh 232 may cover the second hole 230. As such, the acoustic mesh 232 may be configured to prevent debris from entering the microphone 150 without attenuating or enhancing the audio signals received by the microphone 150. The acoustic mesh 232 may be formed of a same or different material as the earbud cover 212.

Referring particularly to FIGS. 3-6, the active noise cancellation system 220 defines a first audio path A1 and a second audio path A2. The first audio path A1 extends from the port 226 of the microphone 150 to the speaker 110. The first audio path A1 specifies the flow of audio signals between the microphone 150 and speaker 110. The second audio path A2 extends from the port 226 to a reference point 236. The second audio path A2 specifies the flow of audio signals between the microphone 150 and reference point 236. The reference point 236 may, for example, correspond to a location within the ear canal 216 of the user. More particularly, the reference point 236 may correspond to a location of an eardrum 238 of the user.

The active noise cancellation system 220 includes an acoustic deflector 234 arranged between the microphone 150 and the speaker 110, as shown. The acoustic deflector 234 may be connected to the acoustic mesh 232 (e.g., via any suitable manner, such as adhesives). That is, the acoustic mesh 232 and the circuit board 222 may be arranged between the acoustic deflector 234 and the microphone 150. The acoustic deflector 234 may be formed of any suitable material, such as a polymer, for deflecting audio signals. Further, the acoustic deflector 234 may be formed via any suitable manufacturing process (e.g., injection molding, extrusion, etc.).

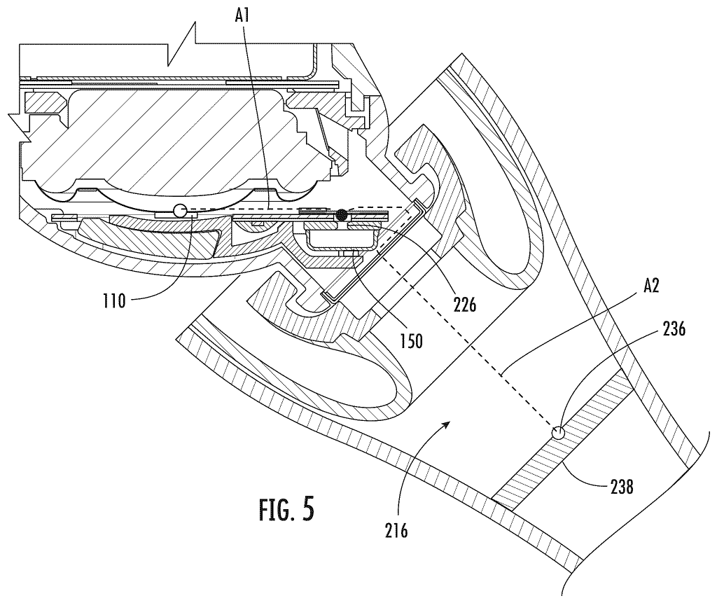

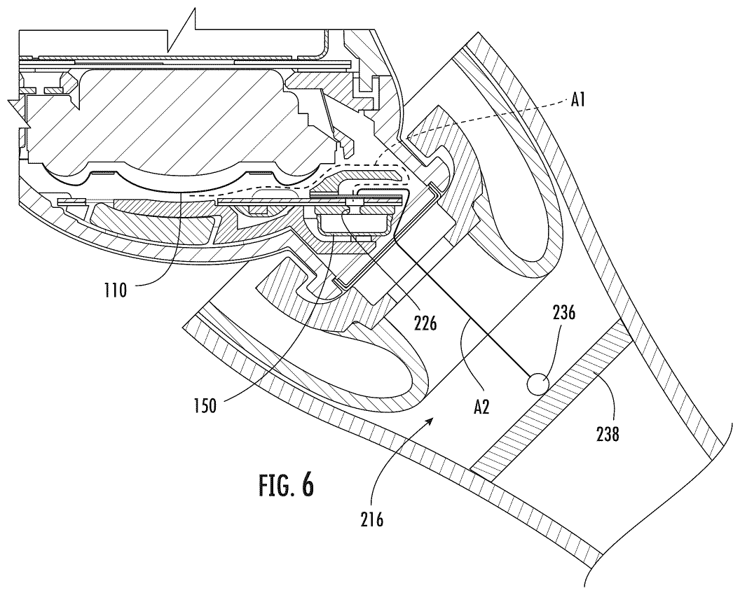

The acoustic deflector 234 may include a first portion 240 that extends away from the microphone 150 and a second portion 242 extending from the first portion 240. The second portion 242 may extend away from the speaker 110 and may overhang the port 226 of the microphone 150. As such, the second portion 242 may direct the second acoustic path A2 away from the speaker 110. More particularly, the second audio path A2 may be directed around an end 244 of the second portion 242 that is spaced from the first portion 240. Directing the second audio path A2 around the end 244 of the second portion 242 increases the length along the second acoustic path A2 (FIG. 6) as compared to active noise cancellation systems having a similar microphone 150 arrangement and lacking the acoustic deflector 234 (FIG. 5).

Without the acoustic deflector 234, as shown in FIG. 5, the lengths along the first and second audio paths A1, A2 may differ. In active noise cancellation systems with the second audio path A2 being longer than the first audio path A1 (FIG. 5), audio playback performance may be improved (e.g., improved howling stability due to phase lag and reduction of occlusion of the acoustic opening), but performance of active noise cancellation may be reduced. Moreover, in active noise cancellation systems with the first audio path A1 being longer than the second audio path A2, active noise cancellation performance may be improved, but performance of the audio playback may be reduced (e.g., reduced howling stability and/or increased occlusion of the acoustic opening). That is, having active noise cancellation systems with differing lengths along the first and second audio paths A1, A2 may reduce performance of one of the audio playback or the active noise cancellation

As such, the acoustic deflector 234 is configured to optimize the first audio path A1 based on the second audio path A2. More particularly, as shown in FIG. 6, the acoustic deflector 234 may be configured such that a length along the first acoustic path A1 is equal to a length along the second acoustic path A2. However, due to manufacturing tolerances, packaging constraints within the earbud assembly 200, and/or a length a user's ear canal, it should be appreciated that the length along the first acoustic path A1 may slightly differ from the length along the second acoustic path A2. Accordingly, the first and second portions 240, 242 may be configured so as to substantially (e.g., within 10%) equalize the lengths along the acoustic paths A1, A2. Substantially equalizing the lengths along the acoustic paths A1, A2 can maximize active noise cancellation while also maximizing the acoustic aspect(s) of the audio playback provided to the user.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A wearable audio device, comprising:
a housing defining a body;
an active noise cancellation system contained within the body, the active noise cancellation system comprising:
a speaker;
a microphone spaced from the speaker; and
an acoustic deflector arranged between the microphone and the speaker, the acoustic deflector configured to optimize a first audio path between a port of the microphone and the speaker based on a second audio path between the port of the microphone and a reference point.

2. The wearable audio device of claim 1, wherein a length along the first audio path equals a length along the second audio path.

3. The wearable audio device of claim 1, wherein the reference point corresponds to a location within an ear canal of a user.

4. The wearable audio device of claim 1, wherein the reference point corresponds to a location of an eardrum of a user.

5. The wearable audio device of claim 1, wherein the active noise cancellation system further includes an acoustic mesh arranged between the microphone and the acoustic deflector.

6. The wearable audio device of claim 5, wherein the active noise cancellation system further includes a circuit board arranged between the microphone and the acoustic mesh, the circuit board including a first hole aligned with the port of the microphone.

7. The wearable audio device of claim 6, wherein the active noise cancellation system further includes a stiffener arranged between the circuit board and the acoustic mesh, the stiffener including a second hole aligned with the port of the microphone.

8. The wearable audio device of claim 7, wherein the acoustic mesh is connected to the stiffener, the acoustic mesh covering the second hole.

9. The wearable audio device of claim 1, wherein the acoustic deflector includes a first portion extending away from the microphone and a second portion extending from the first portion, the second portion extending away from the speaker and overhanging the port of the microphone.

10. The wearable audio device of claim 1, further comprising a protrusion extending from the body, the protrusion defining an acoustic opening, wherein the microphone is arranged, at least partially, within the protrusion and proximate to the acoustic opening.

11. The wearable audio device of claim 10, further comprising a flexible sleeve tip secured over at least a portion of the protrusion, the flexible sleeve tip configured to fit within an ear canal of a user.

12. An active noise cancellation system for a wearable audio device, the active noise cancellation system comprises:
a speaker;
a microphone spaced from the speaker; and
an acoustic deflector arranged between the microphone and the speaker, the acoustic deflector configured to optimize a first audio path between a port of the microphone and the speaker based on a second audio path between the port of the microphone and a reference point.

13. The active noise cancellation system of claim 12, wherein a length along the first audio path equals a length along the second audio path.

14. The active noise cancellation system of claim 12, wherein the reference point corresponds to a location within an ear canal of a user.

15. The active noise cancellation system of claim 12, wherein the reference point corresponds to a location of an eardrum of a user.

16. The active noise cancellation system of claim 12, further comprising an acoustic mesh arranged between the microphone and the acoustic deflector.

17. The active noise cancellation system of claim 16, further comprising a circuit board arranged between the microphone and the acoustic mesh, the circuit board including a first hole aligned with the port of the microphone.

18. The active noise cancellation system of claim 17, further comprising a stiffener arranged between the circuit board and the acoustic mesh, the stiffener including a second hole aligned with the port of the microphone.

19. The active noise cancellation system of claim 18, wherein the acoustic mesh is connected to the stiffener, the acoustic mesh covering the second hole.

20. The active noise cancellation system of claim 12, wherein the acoustic deflector includes a first portion extending away from the microphone and a second portion extending from the first portion, the second portion extending away from the speaker and overhanging the port of the microphone.
